(19) United States
(12) Patent Application Publication
(10) Pub. No.: US 2024/0010304 A1
(43) Pub. Date: Jan. 11, 2024

(54) SYSTEM FOR GENERATING A WARNING SIGNAL

(71) Applicant: Dunlop Oil & Marine Ltd., Pyewipe (GB)

(72) Inventors: Simon Bishop, Beverley (GB); Paul Staton, Grimsby (GB)

(73) Assignee: Dunlop Oil & Marine Ltd., Pyewipe (GB)

(21) Appl. No.: 18/253,775

(22) PCT Filed: Nov. 20, 2020
(86) PCT No.: PCT/EP2020/082883

§ 371 Date: May 19, 2023

(51) Int. Cl. B63B 22/00; G08B 21/18

(52) U.S. Cl. CPC B63B 22/00; G08B 21/18; B63B 2022/006

(57) ABSTRACT

The invention relates to a system (2) for generating a warning signal. The system (2) has a buoyant apparatus (4). The apparatus (4) comprises a collision detection unit (6) which has at least one acceleration sensor (18). Each acceleration sensor (18) is designed to detect an acceleration acting on the apparatus. The collision detection unit (6) comprises a processor unit (10), which is configured for identifying a collision of the apparatus (4) with an unknown object based on the at least one detected acceleration, wherein the processor unit (10) is designed to generate a warning signal when a collision is identified, which signal represents the detected collision. The collision detection unit (6) has a signal interface (12) for transmitting the warning signal.

The invention relates to a system for generating a warning signal.

Systems comprising at least one buoyant apparatus are known from the prior art. An apparatus is preferably understood to be buoyant if at least a part of the apparatus is arranged above a water line if said apparatus is placed in the water such that it can move freely. For example, a floating buoy is an advantageous embodiment of a buoyant apparatus. Floating hoses, floating hose segments, buoyant platforms and/or other buoyant objects can each also represent an example of a buoyant apparatus. The ability of a buoyant apparatus to float often depends on the buoyant apparatus being in an orderly condition. The orderly condition of a buoyant apparatus may be impaired, for example, by the collision of the apparatus with an unknown object. A collision may result in a watertight outer wall of the buoyant apparatus being adversely affected in such a way that water enters the interior of the apparatus. As a result, the previously buoyant apparatus may lose its ability to float. In this case, under unfavorable conditions the apparatus may be completely immersed in the water. This, however, must be avoided. If, for example, the buoyant apparatus is formed by a buoy, and the buoy collides with an unknown object, creating a hole or a crack in the outer wall of the buoy, which then leads to the ingress of water into the buoy interior, the buoy will quickly lose its ability to float. If only a small hole or a small crack appears, there may still be a possibility to retrieve the buoy from the water before the buoy becomes completely immersed in the water. But even if the buoy has a quite large hole and there is not enough time to recover the buoy before it becomes completely immersed in water, the collision of the buoy or a floating apparatus with an unknown object is an event of great interest. This is because knowledge of the collision allows follow-up actions to be taken immediately after the collision has been discovered.

Therefore, the object of the invention is to identify a collision with a buoyant apparatus particularly simply and quickly, even if the buoyant apparatus is floating in the water a great distance away.

The object is achieved according to a first aspect of the invention by a system having the features of claim 1. A system for generating a warning signal is therefore provided. The system comprises a buoyant apparatus. The apparatus comprises a collision detection unit comprising at least one acceleration sensor. Each acceleration sensor is designed to detect an acceleration acting on the apparatus. The collision detection unit comprises a processor unit, which is configured for identifying a collision of the apparatus with an unknown object based on the at least one detected acceleration, wherein the processor unit is designed to generate a warning signal when a collision is identified, which signal represents the detected collision. The collision detection unit has a signal interface for transmitting the warning signal.

The collision detection unit permits a particularly simple and rapid detection of an acceleration acting on the apparatus with the at least one acceleration sensor. The apparatus floating in water transfers the movement of the apparatus to the collision detection unit. If the buoyant apparatus floats in the water, this means that the buoyant apparatus protrudes at least partially above the water surface, whereas another part of the apparatus is located below the water line such that the buoyant apparatus is driven by the current of the water and/or the swell of the water in order to execute a corresponding wave motion. This motion is usually characterized by a small acceleration in the vertical direction and/or a small acceleration in the horizontal direction. A collision of the apparatus with an unknown object, on the other hand, causes a shock. This usually causes a large acceleration pulse. This acceleration pulse usually represents a much greater acceleration than can be caused by the water, especially the associated current and/or the swell. The value of the amplitude of the acceleration measured by means of the at least one acceleration sensor and/or a rate of increase of the acceleration detected by the at least one acceleration sensor can therefore provide information as to whether an acceleration pulse is occurring. Alternatively or in addition, a collision can be detected by means of a pattern recognition of the measured acceleration curve. Alternatively or in addition, the frequency response of the detected acceleration can provide information about a possible collision. Each of the above-mentioned, exemplary options for detecting a collision based on the detected acceleration represents an advantageous embodiment for a configuration of the processor unit. If the processor unit has identified a collision of the apparatus with an unknown object, the processor unit will generate the warning signal representing the identified collision. In a simple embodiment, the warning signal can represent, for example, a status relating to the detected collision. For example, this status can consist of and/or represent “Collision”. This means that the warning signal can be structured in a particularly simple way, for example being formed by one bit. In this case, the warning signal can represent the states “no collision” or “a positively identified collision”. However, the aforementioned, exemplary embodiment of the warning signal is only one of many possible embodiments of the warning signal to represent the identified collision. Thus, the warning signal may, alternatively or in addition, also comprise further data that characterize and/or represent the collision. For example, the warning signal may also include other data representing a value of the detected acceleration, a time of the detected acceleration, a direction of the detected acceleration, and/or a predetermined time period of the detected acceleration. The aforementioned possible data can provide further information about the collision. The warning signal is transmitted by means of the signal interface of the collision detection unit. Thus, the signal interface can be designed for transmitting the warning signal. In addition, the collision detection unit may be designed in such a way that the signal interface transmits the warning signal when it has been generated by the processor unit. For example, the warning signal can be transmitted to a remote receiving unit, where the warning signal is further evaluated. If the buoyant apparatus is designed, for example, as a buoy or as a floating hose, the warning signal can represent, for example, the collision of an unknown object with the buoy or floating hose. If a corresponding warning signal is transmitted via the signal interface, the remote unit can obtain information about this collision and initiate further actions. For example, this information can be displayed on a screen and/or sent to a mobile terminal by a service technician, whereupon a service crew travels by boat to the buoy or floating hose to repair and/or recover the buoy or floating hose, to carry out a repair. By transmitting the warning signal particularly rapidly after the identification of the collision, it can be ensured, in particular in the event of a collision that does not immediately lead to the sinking of the respective buoyant apparatus, that the buoyant apparatus can be repaired and/or replaced particularly quickly. This can increase the security of the use of the respective apparatus and/or equipment coupled to it.

The system may be designed to have a single, buoyant apparatus. However, it is also possible that the system has a plurality of buoyant apparatuses. Each buoyant apparatus can be designed as the buoyant apparatus previously described. For each buoyant apparatus, therefore, the preceding advantageous explanations, preferred features, effects and/or advantages, as explained in connection with the buoyant apparatus of the system, can be referred to in an analogous manner. For example, it may be provided that the system has at least two buoyant apparatuses, wherein one buoyant apparatus is formed by a buoy and the other buoyant apparatus is formed by a floating hose. However, the buoyant apparatus may also be formed by one part of a multi-part apparatus. For example, a floating hose may be formed by a plurality of floating hose segments coupled in series with one another. One or each of the hose segments may form a buoyant apparatus of the system.

A further advantageous configuration of the system is characterized by the fact that the warning signal additionally represents characterizing data representing the apparatus. The processor unit may be designed to generate the warning signal upon identification of the collision in such a way that the warning signal represents the identified collision and characteristic data identifying the apparatus. The apparatus can be uniquely identified by means of the characteristic data. The characteristic data may include, for example, data that represents an identification number of the apparatus. This number can be uniquely assigned to the respective apparatus. If the warning signal which also represents the characteristic data is transmitted, the warning signal or the characteristic data represented by the warning signal can be used to determine which apparatus has undergone a collision. Follow-up actions can be derived from this. This is because the knowledge about the respective apparatus helps, for example, in repairing the respective apparatus. If, for example, the apparatus is a buoy, other actions may be useful, compared to the case where the apparatus is formed by a floating hose. In addition, location information about the apparatus can also be derived from the identification of the apparatus. This is because a local area in which the respective apparatus can be found is usually known.

A further advantageous configuration of the system is characterized by the fact that the warning signal additionally represents the acceleration detected during the collision. The warning signal can therefore also provide information about the acceleration that led to the identification of the collision. The detected acceleration is preferably the value of the detected acceleration. The collision signal can provide information, for example, about the detection of the collision as such and about the value of the detected acceleration. If the warning signal is transmitted directly or indirectly to a receiver, further findings and/or actions can be derived at the receiver based on the knowledge of the collision and the value of the acceleration that led to the collision. For example, the value of the acceleration can be construed as an indication of how severe the collision was. For example, a minor collision may indicate that although there may be damage to the buoyant apparatus, it is very likely that no water will enter the interior of the buoyant apparatus. On the other hand, a very large value of the acceleration may indicate that there is severe damage to the buoyant apparatus, so that water will very likely enter the interior of the buoyant apparatus. The information obtainable from the warning signal therefore allows interpretation of the severity of the collision and also allows appropriate actions to be taken to repair and/or recover the buoyant apparatus, if appropriate.

A further advantageous embodiment of the system is characterized in that the warning signal also represents a frequency and/or a number of further collisions which are identified during a predetermined period after the detection of the initially detected collision. The initially detected collision is preferably the collision that is first detected as a collision. The predetermined period may be limited to a period that is useful in practice. For example, the predetermined time period can be at least 10 sec, at least 1 min, or at least 2 min. For example, the predetermined time period may be limited to a maximum of 10 min, 30 min, or 1 h. In principle, it can happen that a collision of the buoyant apparatus with an unknown object occurs only once. In this case, no further collisions would be recorded in the predetermined time period. So the number would be 0 in this case. In practice, however, it can also happen that the buoyant apparatus collides with the unknown object multiple times after the first collision and during the predetermined period thereafter. The number and/or frequency of the collisions may indicate, or at least be interpreted as, an indication of how severely the buoyant apparatus is damaged and/or impaired due to the collisions. If the initially detected collision, i.e. the first collision, is of minor severity, this could lead to the conclusion, based on a sole consideration of this collision and/or the acceleration detected for the purpose, that there might only be a small amount of damage to the buoyant apparatus. If, on the other hand, the frequency and/or number of further collisions in the predetermined period after the initially detected collision are also taken into account, this could lead to the conclusion that there is not only minor, but a moderate to major impairment and/or damage to the buoyant apparatus. This can lead to different follow-up actions. It is therefore advantageous if the warning signal also represents the frequency and/or the number of further collisions. In particular, the warning signal can thus represent the detection of the initially detected collision and the frequency and/or number of further collisions. In addition, the warning signal may represent the detected acceleration of the initially detected collision and/or the detected acceleration of each of the collisions, i.e. the initially detected collision and each of the collisions detected in the predetermined period.

A further advantageous embodiment of the system is characterized in that the collision detection unit of the buoyant apparatus comprises a plurality of acceleration sensors. Each acceleration sensor is designed to detect an acceleration acting on the apparatus. The acceleration sensors may be designed for detecting the corresponding acceleration from different directions relative to the collision detection unit or the buoyant apparatus. In particular, the plurality of acceleration sensors of the collision detection unit may be distributed in such a way as to detect an acceleration acting on the buoyant apparatus from each direction. This offers the advantage that every collision of the buoyant apparatus with an unknown object can be detected and identified by the collision detection unit.

A further advantageous embodiment of the system is characterized in that at least one of the acceleration sensors is arranged and designed for detecting an acceleration in a horizontal plane of the apparatus. The horizontal plane preferably corresponds to the plane of the water in which the buoyant apparatus is introduced and is floating. In practice, it has been found that a collision of the buoyant apparatus often occurs with an unknown object that is also floating in the water. This then leads to an acceleration of the buoyant apparatus occurring at least substantially in the horizontal plane. It is therefore preferred that at least one of the acceleration sensors is arranged and designed for detecting an acceleration acting on the apparatus in the horizontal plane. These sensors can therefore be used to detect the commonly occurring case of a collision with an object that is also floating.

A further advantageous embodiment of the system is characterized in that an acceleration limit value is stored by the collision detection unit, wherein the processor unit is configured to positively identify the collision of the device with the unknown object if the at least one detected acceleration is greater than the acceleration limit value. If the collision detection unit comprises a plurality of acceleration sensors, the processor unit can be configured to positively identify a collision between the buoyant apparatus and the unknown object if one of the detected accelerations from the acceleration sensors is greater than the acceleration limit value. The acceleration limit value may be predefined such that a typical swell and/or typical current of the water do not result in an incorrect or false positive identification of a collision. In particular, the acceleration limit may be predefined in such a way that a collision with an unknown object is only positively identified as an actual collision if the unknown object has at least a predefined weight. The weight may be defined, for example, by the weight of a boat or ship.

The acceleration limit can be a predefined acceleration limit value. The acceleration limit value may also be adjusted so that a collision with a smaller and/or lighter, unknown object is already positively detected as a collision. This is particularly advantageous if the buoyant apparatus can undergo major damage even in the event of a minor collision.

Another advantageous embodiment of the system is characterized in that the system comprises an interface for receiving weather data and/or for receiving marine data, and wherein the system is designed to adjust the acceleration limit value based on the weather data and/or the marine data. The weather data preferably represents the current wind strength, the current wind direction, a forecast of the wind strength and/or a forecast of the wind direction. The marine data preferably represents the current strength of the current, the current direction, a forecast of current strength and/or a forecast of current direction, in each of the above cases for the water in which the buoyant apparatus can float. Strong wind and/or a strong current in the water can cause higher waves. The waves will cause the buoyant apparatus to move vertically when it is floating in this type of water. The acceleration limit value may be adjusted based on the weather data and/or marine data such that an acceleration caused by the water and/or wind and acting on the buoyant apparatus is not identified as a collision. This allows an error rate of the collision detection unit or the associated processor unit to be kept particularly low.

An advantageous embodiment of the system is characterized in that the signal interface is at least partially designed for wireless transmission of the signal. The signal interface can therefore be designed to transmit the warning signal by radio. In particular, the signal interface can be designed for transmitting, in particular wirelessly transmitting, the warning signal. The collision detection unit may also be configured and/or designed such that the signal interface transmits the warning signal when a collision is detected by means of the processor unit. This allows the information about the collision event to be forwarded particularly quickly.

A further advantageous embodiment of the system is characterized in that the collision detection unit is designed for recording the or each acceleration detected by the at least one acceleration sensor for a predetermined period of time following an identified collision. The processor unit is preferably designed to generate a data signal representing the recorded acceleration or each recorded acceleration. The signal interface may be designed for transmitting the data signal. The recording of the acceleration detected by the at least one acceleration sensor for a predetermined time offers the possibility that as a result of the recording, the graph of the acceleration is represented by the corresponding recording. The graph of the acceleration can provide information as to whether and to what extent the buoyant apparatus has been damaged by the at least one collision. If, for example, it can be identified from the graph that a plurality of further collisions has also taken place after the first or initial collision, this indicates, for example, that there could be severe damage to the buoyant apparatus. Other patterns in the acceleration graph may indicate other types of damage and/or an expected degree of the damage. The data signal generated by the processor unit represents the recorded acceleration. The data signal can be transmitted by the signal interface. The signal interface can therefore be designed for transmitting the warning signal and the data signal. The warning signal and the data signal can be combined with each other. This results in a combined warning data signal. This warning data signal can be transmitted by the signal interface. In particular, the warning data signal can be sent by the signal interface, in particular wirelessly.

The collision detection unit can be designed in such a way that the collision detection unit operates alternately in a sleep mode and in a wake mode. In the sleep mode, the collision detection unit is designed to detect the acceleration acting on the apparatus periodically with a first detection frequency. The collision detection unit may be configured to switch from the sleep mode to the wake mode when a collision is identified by the collision detection unit. In the wake mode, the collision detection unit is preferably configured so as to detect the acceleration acting on the buoyant apparatus periodically with a second detection frequency. Preferably, the second detection frequency is greater than the first detection frequency. For example, the second detection frequency can be at least twice as large as the first detection frequency. In addition, it is preferably provided that the collision detection unit is designed to switch from the wake mode to the sleep mode if no further collision is detected during the predefined time period. In addition, it is preferably provided that the collision detection unit is designed for recording the acceleration detected by the at least one acceleration sensor only in the wake mode. In the sleep mode, the recording of the at least one acceleration is preferably not carried out. The collision detection unit can be designed appropriately for this purpose. The collision detection unit can therefore, for example, switch to the wake mode on the detection of a collision, in order then to carry out the recording of the acceleration detected by the at least one acceleration sensor for the predetermined period of time. The collision detection unit, in particular the associated processor unit, may be designed to check the recorded acceleration in regard to a possible further collision. If this check detects a further collision, a new start time can be set for the predefined time period from the time of detection of a further collision. This ensures that the last collision detected is followed by a predetermined period of time during which no further collision occurred. The collision detection unit can then return to the sleep mode.

A further advantageous embodiment of the system is characterized in that the system has a plurality of the buoyant apparatuses, each having one associated collision detection unit. Each buoyant apparatus can thus be designed as the buoyant apparatus previously described. For each buoyant apparatus, therefore, the preceding advantageous explanations, preferred features, effects and/or advantages, as explained in connection with the buoyant apparatus of the system according to the first aspect of the invention and/or one of the associated advantageous embodiments, are referred to in an analogous manner. The plurality of buoyant apparatuses may be arranged to form a strand and be mechanically connected to each other in an appropriate manner. The connection between each two of the buoyant apparatuses may be formed as a releasable, mechanical connection.

A further advantageous embodiment of the system is characterized in that the system has a coupling unit and a floating hose, which has a plurality of floating hose segments that are coupled to one another in series. One end of the floating hose is coupled to the coupling unit. This can be a mechanical coupling. At least one of the hose segments is designed as a buoyant apparatus with a corresponding collision detection unit. The coupling unit may be designed as a stationary and/or non-floating unit. For example, the coupling unit may be formed by a fixed object which is attached to land or to the sea bed, for example. It is also possible, however, for the coupling unit to be formed by a floating body. Thus, the coupling unit may be formed by a movable and/or buoyant coupling unit. The coupling unit may be formed, for example, by a pontoon or another floating body, which can be arranged floating on water together with the floating hose.

The coupling unit preferably comprises a mechanical connector which is designed for connecting to the first end of the floating hose. Thus, the floating hose with the associated first end can be mechanically coupled to the connector of the coupling unit. This may be a mechanical connection.

Another advantageous embodiment of the system is characterized in that the system comprises a floating buoy and a buoyant, floating hose, which comprises a plurality of floating hose segments connected in series, wherein a first end of the floating hose is coupled to the buoy, and wherein at least one of the buoy and the hose segments is designed as a buoyant apparatus with the corresponding collision detection unit. For example, the buoy can form the buoyant apparatus. However, it is also possible that one of the hose segments forms the buoyant apparatus. If multiple buoyant apparatuses are provided for the system, the buoy can form, for example, a first, buoyant apparatus and at least one of the hose segments can form a further, second buoyant apparatus. Each of the buoyant apparatuses, in particular also the buoy and the one hose segment, may be formed in the manner of the buoyant apparatus that has been explained in connection with the first aspect of the invention and/or one of the associated advantageous embodiments. For these embodiments of the system of the buoyant apparatus as a buoy or hose segment also, reference is therefore made in a similar manner to the corresponding preferred features, effects and/or advantages as have been explained in conjunction with the buoyant apparatus.

A further advantageous embodiment of the system is characterized in that the buoy is designed as a buoyant apparatus with a collision detection unit and at least one of the hose segments are each designed as a buoyant apparatus with a collision detection unit. Thus, the system has at least two buoyant apparatuses, namely the buoy and at least one of the hose segments.

A further advantageous embodiment of the system is characterized in that at least one of the acceleration sensors is designed and/or arranged for detecting a lateral acceleration acting on the buoy or the floating hose. Thus, the sensor used for detecting the lateral acceleration can be arranged in such a way as to detect the lateral acceleration in a horizontal plane. The buoy and the floating hose are preferably mechanically coupled to each other. A lateral acceleration acting on the floating hose can therefore also lead to a corresponding lateral acceleration of the buoy, even if the acceleration may be smaller. Nevertheless, a lateral acceleration which is due to an acceleration of the floating hose can also be detected on the buoy. The converse also applies. Thus, it may preferably be provided that the at least one acceleration sensor is arranged centrally between the buoy and an end of the floating hose remote from the buoy. The acceleration sensor can be part of a collision detection unit which is assigned to a hose segment as an embodiment of the buoyant apparatus. However, it is also possible that the buoy and the floating hose have a plurality of collision detection units which are distributed between the buoy and the end of the floating hose remote from the buoy.

Another advantageous embodiment of the system is characterized in that the system comprises a communication unit which is coupled to each signal interface via an associated signal connection, so that the warning signal of each collision detection unit and preferably the data signal of each collision detection unit can be transmitted via the respective signal connection to the communication unit, wherein the communication unit is configured for generating a transmission signal based on the at least one warning signal and/or data signal so that the transmission signal represents the at least one receiving signal, and wherein the communication unit is designed for transmitting the transmission signal. By means of the communication unit, the information from the at least one warning signal and/or of the at least one data signal can be merged and/or bundled in the transmission signal. This is advantageous for transmitting the transmission signal, since less data needs to be transferred. The communication unit may be designed integrally with one of the signal interfaces and/or with one of the collision detection units. In this case, the transmission of the warning signal of the signal interface or collision detection unit with which the communication unit is integrally designed, can be performed internally and/or via cables. The warning signals of the other signal interfaces or collision detection units can be transmitted wirelessly to the communication unit.

A further advantageous embodiment of the system is characterized in that the communication unit is designed for sending the transmission signal wirelessly. The transmission signal can be sent via a satellite. For example, the transmission signal can be sent to a stationary base station and/or to a receiving unit of a ship. Thus, the base station or the receiving unit of the ship can receive the transmitted information that a collision of at least one buoyant apparatus has occurred. Additional information related to this collision may be transferred if necessary.

A further advantageous refinement of the system is characterized in that the system comprises a navigation unit which is designed to receive a satellite-based wireless navigation signal, wherein the navigation unit is configured to determine a geographical location of the system on the basis of the navigation signal, and wherein the communication unit is configured to adapt the transmission signal in such a way that the transmission signal also represents the geographical location. For example, the transmission signal can represent the geographical location, the warning signal, and the data signal bundled together. If the transmission signal is sent, the receiver, for example the base station, can receive the information about the collision of the at least one buoyant apparatus with an unknown object and at the same time receive the geographical location of the system and thus at least also the approximate geographical location of the buoyant apparatus that has collided with an unknown object. In addition, the data signal and thus possible further information can also be made accessible to the receiver.

Further features, advantages and possible applications of the present invention can be gleaned from the following description of the exemplary embodiments and the figures. Here, all of the features described and/or illustrated in the figures form the subject matter of the invention individually and in any desired combination, even independently of the composition thereof in the individual claims, or the back-references therein. In the figures, furthermore identical reference symbols are used for identical or similar objects.

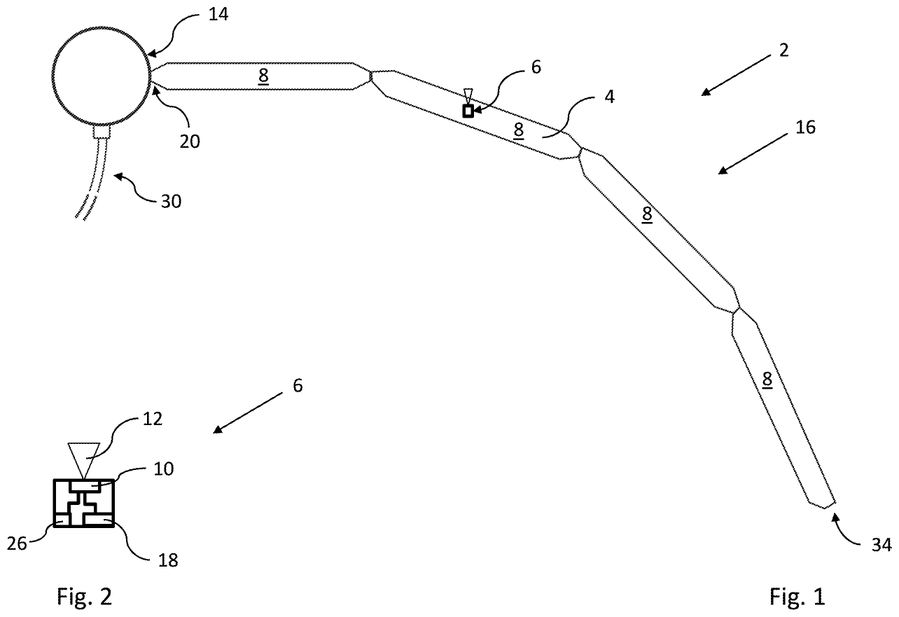

FIG. 1 shows a schematic view of an advantageous embodiment of the system.

FIG. 2 shows a schematic view of an advantageous embodiment of the collision detection unit.

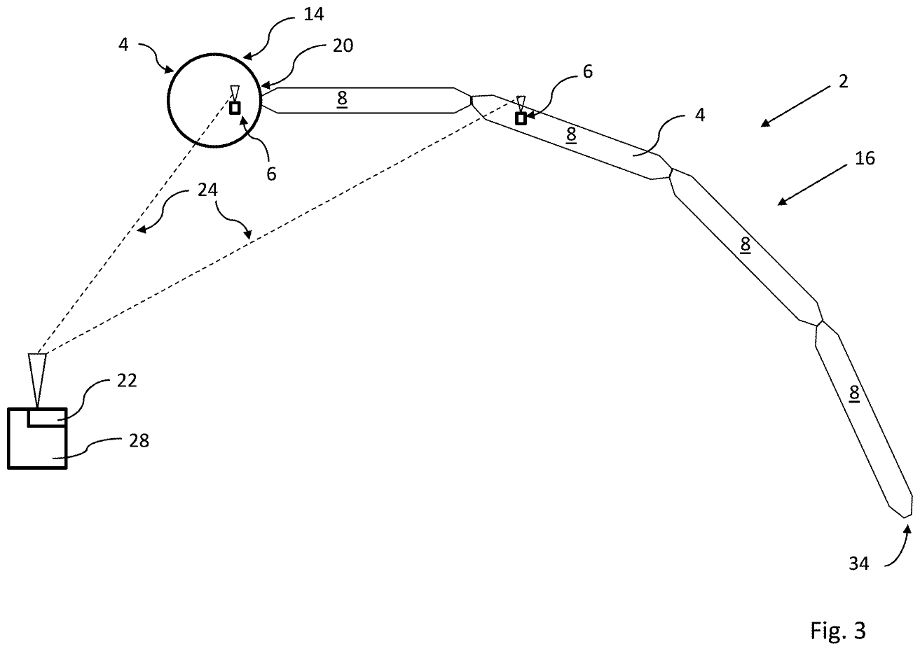

FIG. 3 shows a schematic view of a further advantageous embodiment of the system.

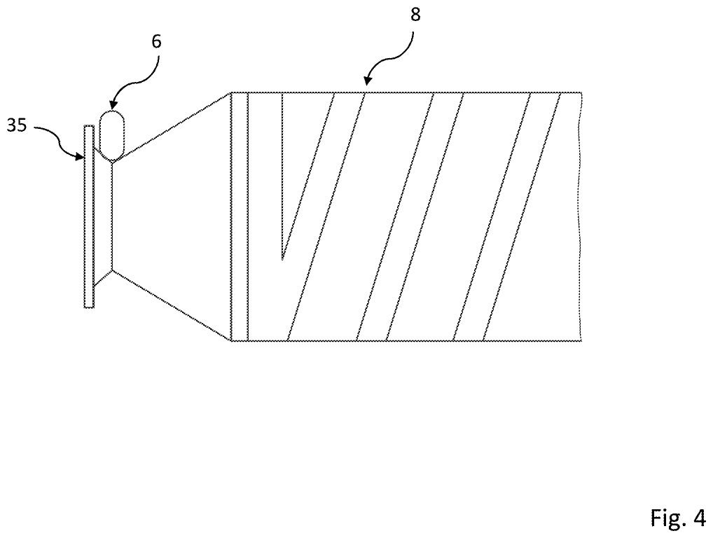

FIG. 4 shows part of a hose segment, which forms an advantageous embodiment of a buoyant apparatus.

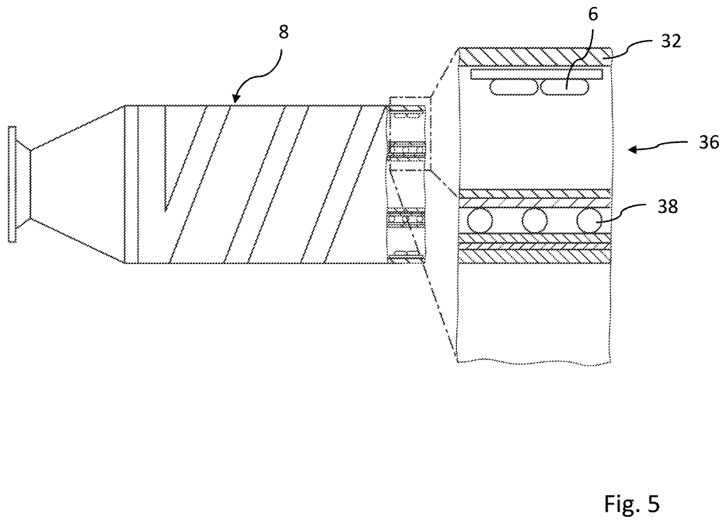

FIG. 5 shows a part of a further embodiment of a hose segment, which also forms an advantageous embodiment of a buoyant apparatus.

FIG. 1 shows a schematic view of an advantageous embodiment of a system 2 with a buoyant apparatus 4. The buoyant apparatus 4 is formed by a hose segment 8, wherein the hose segment 8 comprises a collision detection unit 6. When, therefore, in referring to FIG. 1 the buoyant apparatus 4 is mentioned, this preferably means the hose segment 8 with the associated collision detection unit 6. The system 2 also has additional hose segments 8. Overall, the hose segments 8 are mechanically coupled to each other in series to form a hose strand. The hose segment 8 which forms the buoyant apparatus 4 can be mechanically coupled between two further hose segments 8, for example. Each of the hose segments 8 may be designed as a floating hose or as a floating hose segment. The hose segments 8 are preferably coupled in series to form a strand in such a way that the hose segments 8 jointly form a buoyant floating hose 16. The floating hose 16 or each of the hose segments 8 can therefore float in the water. In calm water, for example, at least 20% of the floating hose 16 or 20% of each hose segment 8 can be arranged above a water line.

A first end 20 of the floating hose 16 is coupled to a buoy 14. The buoy 14 can be designed as a floating buoy 14. The buoy 14 can also form a part of the system 2. Furthermore, an underwater hose 30 can be coupled to the buoy 14. The buoy 14 may be designed in such a way as to form a fluid connection between the underwater hose 30 and the first end 20 of the floating hose 16. The underwater hose 30 is preferably not part of the system 2.

The buoy 14 and the attached floating hose 16 are often used in practice to direct a conveyable fluid, in particular mineral oil, which is provided by the underwater hose 30, to a second end 34 of the floating hose 16. This is used, for example, if the second end 34 of the floating hose 16 is coupled to a tanker to direct the fluid from the underwater hose 30 via the buoy 14 and the floating hose 16 to the tanker so that the latter can collect the fluid, in particular the mineral oil. Once the tanks of the tanker are filled, the second end 34 of the floating hose 16 is uncoupled from the tanker again. Thereupon, the floating hose 16 together with the buoy 14 floats freely in the water of the sea. In practice, several hours may pass before another tanker steers to the second end 34 of the floating hose 16 to attach the second end 34 of the floating hose 16. In the above-mentioned interim period of several hours, it is possible that the floating hose 16 will collide with an unknown object. The collision can impair the floating hose 16 mechanically in such a way that the floating hose 16 is partially defective or there is a risk of leakage of the fluid into the environment, in particular into the sea. This, however, must be avoided.

The system 2 therefore comprises a hose segment 8, which forms a buoyant apparatus 4 of the system 2. This hose segment 8 therefore also comprises the collision detection unit 6. The collision detection unit 6 can be arranged and/or fixed on the outside of a jacket wall of the hose segment 8. However, it is also possible that the collision detection unit 6 is partially or completely embedded in a shell wall of the hose segment 8. It is preferably provided that the collision detection unit 6 has a fixed connection to the remaining hose segment 8. If this hose segment 8 collides with an unknown object, this hose segment 8 is accelerated in a direction that is opposite to the direction of motion of the unknown object. But even if the hose segment 8 which forms the buoyant apparatus 4 does not itself collide with the unknown object, but one of the further hose segments 8 of the system 2 or the buoy 14 instead, the motion caused by the collision will be transmitted to the hose segment 8, which is designed as the buoyant apparatus 4 and therefore also comprises the collision detection unit 6. The transmitting movement thus also causes an accelerated movement in this hose segment 8, which is transferred to the collision detection unit 6.

FIG. 2 shows a schematic illustration of an advantageous refinement of the collision detection unit 6. Such a collision detection unit 6 can form the collision detection unit 6 of the hose segment 8 which forms the buoyant apparatus 4. The collision detection unit 6 illustrated in an exemplary and schematic manner in FIG. 2 comprises an acceleration sensor 18, which is designed for detecting an acceleration acting on the collision detection unit 6. The collision detection unit 6 in the example shown in FIG. 1 forms a part of the hose segment 8, so that the acceleration sensor 18 is designed and/or arranged to detect an acceleration acting on the hose segment 8. Thus, the acceleration sensor 18 can detect an acceleration acting on the buoyant apparatus 4.

Although the embodiment of the collision detection unit 6 shown in FIG. 2 schematically represents only one acceleration sensor 18, it is entirely possible that the collision detection unit 6 has a plurality of acceleration sensors 18. In this case, each acceleration sensor 18 may be designed and/or arranged for detecting an acceleration and thus for detecting an acceleration acting on the collision detection unit 6 and/or for detecting an acceleration acting on the buoyant apparatus 4 or the hose segment 8. The preceding and the following explanations can therefore apply in an analogous manner if the collision detection unit 6 has a plurality of acceleration sensors 18.

The collision detection unit 6 also comprises a processor unit 10, which is coupled to the or each acceleration sensor 18 in such a way that a sensor signal from each acceleration sensor 18 is transmitted to the processor unit 10, wherein the respective sensor signal represents the acceleration detected by the respective acceleration sensor 18. The processor unit 10 therefore has access to the information about the acceleration detected by the at least one acceleration sensor 18. The processor unit 10 is configured to identify a collision of the buoyant apparatus 4 or the hose segment 8 with an unknown object on the basis of the at least one detected acceleration.

In FIG. 1, one of the hose segments 8 forms the buoyant apparatus 4 with the associated collision detection unit 6. If this hose segment 8 collides with an unknown object, the acceleration sensor 18 of the collision detection unit 6 detects an acceleration acting on the hose segment 8, which has an associated amplitude and/or direction not usually caused by the water of the sea on which the hose segment 8 is floating. This is because the water can cause a certain lateral movement of the hose segment 8 and/or also cause a movement in the horizontal direction due to an appropriate swell, but both movements are associated with a small acceleration. On the other hand, a collision with an unknown object often causes a sudden impulse, which leads to a brief, strong acceleration of the hose segment 8. This short-term acceleration is detected by the acceleration sensor 18 of the collision detection unit 6. Based on the acceleration detected by the acceleration sensor 18, the processor unit 10 can identify whether the detected acceleration is due to a normal water-induced acceleration or whether the acceleration is due to the collision with an unknown object. The processor unit 10 can, for example, compare the value of the acceleration, in particular the maximum value of the detected acceleration, with an acceleration limit value stored by the collision detection unit 6. The processor unit 10 can have access to this acceleration limit value. The acceleration limit value may be predefined such that a normal swell and/or normal water current cause an acceleration of the hose segment 8 which is less than the acceleration limit value. Thus, for example, the acceleration limit value can be predefined in such a way that a normal swell of the water and/or a normal current of the water does not lead to an incorrect identification of a collision. For the processor unit 10 can be configured to detect the collision of the buoyant apparatus 4 or of the hose segment 8 with the unknown object positively only if the at least one acceleration detected by the acceleration sensor 18 is greater than the acceleration limit value. If no acceleration detected by the at least one acceleration sensor 18 is greater than the acceleration limit value, the processor unit 10 does not detect a collision with an unknown object.

The processor unit 10 of the collision detection unit 6 is also designed to generate a warning signal when a collision is detected, so that the warning signal represents the detected collision. If the buoyant apparatus 4 is formed as in the example of FIG. 1 by one of the hose segments 8, the processor unit 10 will generate a warning signal when a collision of the hose segment 8 with the unknown object is detected by the processor unit 10, so that the generated warning signal represents the detected collision of the hose segment 8 with the unknown object. In a particularly simple case, the warning signal can be represented by a data word with one bit. For example, setting the bit to 1 can represent a positively identified collision. On the other hand, if the bit is set to 0, this represents that no collision has occurred. In principle, however, the warning signal may also include additional data. For example, the warning signal may indicate the time of the collision, the value of the acceleration during the collision, the location at which the unknown object collided with the buoyant apparatus 4 or the hose segment 8, characteristic data identifying the buoyant apparatus 4 or the hose segment 8, and/or comprise other data related to the collision. Before further discussion of this possible other data that can be represented by the warning signal, it will first be explained how to draw attention to the collision.

The collision detection unit 6 has a signal interface 12, designed for transmitting the warning signal. The collision detection unit 6 can be designed to emit the warning signal by means of the signal interface 12 when the warning signal is generated or when a collision is positively identified by the processor unit 10. The warning signal can be received by a receiver in order to perform further actions. The receiver may be formed by a stationary receiving unit. However, it is also possible that the receiver or a further receiver is arranged on a ship. Thus, the information about the collision with the buoyant apparatus 4 or the hose segment 8 can be forwarded particularly easily in order to take follow-up actions. If, for example, a collision of the hose segment 8 which forms the buoyant apparatus 4 has occurred, the collision can cause such damage to a shell wall of the hose segment 8 that when the hose segment 8 is used, fluid or oil will escape from the shell wall unintentionally. This, however, must be avoided. Therefore, the hose segment 8 should be replaced before further use of the floating hose 16. However, replacement of the hose segment 8 can only be initiated if the damage has been positively identified. Due to the rapid transmission of the discovery of the collision of the hose segment 8, actions can therefore be taken immediately to perform a quick replacement of the hose segment 8. If this does not take place and, for example, a tanker is steering towards the floating hose 16 to collect oil, in an unfavorable case this can lead to a long time delay, if the replacement of the hose segment 8 is only begun after the tanker arrives. The system 2 therefore allows the consequential costs for the waiting time of the tanker to be minimized.

During a period when the second end of 34 of the floating hose 16 is not coupled to a tanker, the floating hose 16 often floats freely in the sea. It has therefore proved to be advantageous if the signal interface 12 is designed for wireless transmission of the warning signal. The signal interface 12 can therefore also be designed and/or designated as a wireless signal interface 12. The warning signal can thus be transmitted and/or sent by radio. This is particularly advantageous if the signal interface 12 is designed for transmitting the warning signal to a satellite. As a result, the system 2 can be deployed particularly far away from a coast. This is because, even if the system 2 is a long distance away from the coast, the warning signal can be sent to a satellite first, so that the warning signal is transmitted from the satellite to a desired receiver via further communication units.

In practice, it may occur that a moving ship, a moving boat and/or another object floating in the water collides with the floating hose 16 and in particular with the hose segment 8, which forms the buoyant apparatus 4. A collision must be avoided in any event, however, the strength of the collision can be decisive as to whether the buoyant apparatus 4 or the hose segment 8 thereby undergoes such a level of impairment and/or destruction as to force follow-up actions to be taken. It is therefore preferably provided that the processor unit 10 be designed to generate the warning signal upon identification of the collision in such a way that the warning signal at least also represents the acceleration detected during the collision. The detected acceleration here preferably means the magnitude or value of the detected acceleration. The acceleration detected during the collision can be the maximum acceleration detected by the acceleration sensor 18 during the collision. If the warning signal is transmitted by the signal interface 12, in particular broadcast, the information as to how severely the collision occurred can also be transferred with it. This is because the detected acceleration or the value or magnitude of the detected acceleration provides information on the loading to which the floating hose 16 was subjected during the collision. From this it is possible to infer whether an acceptable deformation or even damage to the hose segment 8 might have occurred. Appropriate measures for the repair and/or replacement of the hose segment 8 can therefore be initiated in a targeted manner.

FIG. 1 shows the floating hose 16 in a schematic plan view. A collision of the floating hose 16 with an unknown floating object therefore usually occurs in such a way that the unknown object hits the floating hose 16 from the side. This causes a short, abrupt acceleration of the floating hose 16 at the collision site in a horizontal plane. For the system 2, it is therefore preferably provided that the at least one acceleration sensor 18 of the collision detection unit 6 is arranged and/or designed so as to detect an acceleration of the collision detection unit 6 or the buoyant apparatus 4 in a horizontal plane. In the example in FIG. 1 the buoyant apparatus 4 is formed by a hose segment 8. Thus, the at least one acceleration sensor 18 of the collision detection unit 6 can be arranged and/or designed so as to detect an acceleration acting on the hose segment 8 in a horizontal plane. This design allows the particularly reliable and efficient detection of an acceleration that can occur during a collision of an unknown floating object with the hose segment 8 which forms the buoyant apparatus 4. As previously mentioned, due to the mechanical coupling of the hose segment 8 with the other hose segments 8, an acceleration of another hose segment 6 can also be detected by the collision detection unit 8 since this acceleration is transmitted to all hose segments 8 due to the mechanical coupling.

However, a more precise detection of a collision of an unknown object with the floating hose 16 or with the buoy 14 coupled to the floating hose 16 is possible if the system 2 comprising the buoy 14 and the floating hose 16 comprises a plurality of buoyant apparatuses 4.

FIG. 3 shows a schematic view of a further, advantageous embodiment of the system 2. The system 2 comprises a floating hose 16 with a plurality of hose segments 8 which are coupled to form a hose strand, wherein a first end 20 of the floating hose 16 is coupled to a buoy 14. The buoy 14 forms part of the system 2. In addition, it is preferably provided that one of the hose segments 8 forms a buoyant apparatus 4. This may also be referred to as the first buoyant apparatus 4. In addition, it is preferably provided that the buoy 14 forms a further buoyant apparatus 4. This buoyant apparatus 4 may also be referred to as the second buoyant apparatus 4. The system 2 thus comprises two buoyant apparatuses 4, which are formed by one of the hose segments 8 and by the buoy 14. With regard to the first buoyant apparatus 4, which is formed by one of the hose segments 8, reference is made to the preceding explanations in connection with FIGS. 1 and 2 in an analogous manner. The buoy 14 likewise comprises a collision detection unit 6. With regard to the collision detection unit 6 for the buoy 14, reference is made to the preceding explanations, preferred features, technical effects and/or advantages as were explained in connection with the collision detection unit 6 of FIGS. 1 and 2. The collision detection unit 6 of the buoy 14 can therefore also have an acceleration sensor 18 which is designed to detect an acceleration acting on the collision detection unit 6 of the buoy 14 and thus to detect an acceleration acting on the buoy 14. The processor unit 10 of the collision detection unit 6 of the buoy 14 may also be designed to generate a warning signal when a collision has been previously identified by the processor unit 10 based on a detected acceleration. The warning signal may be generated by the processor unit 10 in such a way that it represents the detected collision. The warning signal generated by this collision detection unit 6 may also include further data and/or information. The corresponding explanations, preferred features and/or technical effects as were previously explained in connection with the warning signal are referred to in an analogous manner.

The system 2 shown in FIG. 2 can therefore comprise two collision detection units 6, wherein each of the collision detection units 6 is selected for transmitting a warning signal by means of their respective associated signal interfaces 12.

The configuration of the system 2 shown in FIG. 3 offers the advantage that individual parts of the system 2 can be replaced without further complex electrical connections having to be disconnected and/or restored. The system 2 can therefore identify a possible collision with an unknown object particularly robustly and emit an appropriate warning signal. In addition, the use of multiple buoyant apparatuses 4 each having a collision detection unit 6 offers the possibility that a collision of the system 2 with an unknown object can be detected simultaneously by both associated collision detection units 6. This can create redundancy, which allows a particularly reliable and valid detection of a collision of the system 2 with an unknown object.

A further embodiment (not shown) of the system 2 is based on the embodiment of the system 2 shown in FIG. 1, wherein the collision detection unit 6 comprises a plurality of acceleration sensors 18. The acceleration sensors 18 can be distributed between the buoy 14 and the second end 34 of the floating hose 16. Each of the acceleration sensors 18 can be connected to the processor unit 10 via a cable connection. This configuration allows a collision of the system 2 with an unknown object at any point to be detected by means of one of the plurality of acceleration sensors 18. The processor unit 10 can be configured to positively identify a collision with the unknown object if, for example, the acceleration detected by one of the acceleration sensors 18 is greater than an acceleration limit value. If the collision has been detected by means of the processor unit 10, the warning signal explained previously can be broadcast by means of the signal interface 12.

In FIGS. 4 and 5, a part of a hose segment 8 is shown, wherein the hose segment 8 in each case forms a buoyant apparatus 4 for the system 2. In the embodiment shown in FIG. 4, the collision detection unit 6 is arranged on and/or fixed to an end-side flange element 35, wherein the flange element 35 is designed for connecting to a flange element 35 of a further hose segment 8 and/or to the buoy 14.

FIG. 5 shows a further advantageous embodiment of a part of a hose segment 8, which forms a buoyant apparatus 4 of the system 2. In this case a part of the hose wall 36 of the hose segment 8 is shown enlarged. From the enlarged representation of the hose wall 36 it is apparent that the hose wall 36 has an outer layer 32, which may be formed by rubber material. But the radially inwardly arranged layers of the hose wall 36 can also consist of rubber material or be formed thereby. In addition, strengthening supports 38 can be embedded in the rubber material of the hose wall 36. It is possible for the collision detection unit 6 to be completely or at least partially embedded in the rubber material of the hose wall 36. In this case, the collision detection unit 6 may be protected from being destroyed in the event of a collision with an unknown object. This applies in particular at least if the collision does not occur directly radially outwards with respect to the collision detection unit 6, but axially offset with respect to the collision detection unit 6.

It can also preferably be provided that the system 2 has a navigation unit 26. Purely by way of example, such a navigation unit 26 is shown in FIG. 2, wherein the navigation unit 26 forms part of the collision detection unit 6. The navigation unit 26 is designed to receive a satellite-based, wireless navigation signal. In addition, the navigation unit 26 is configured to determine a geographical location based on the navigation signal. This location may be understood to mean a location of the collision detection unit 6 site and/or a location of the system 2. The collision detection unit 6 can be designed and/or configured such that the warning signal at least also represents the geographical location of the collision detection unit 6, of the buoyant apparatus 4 with this collision detection unit 6, and/or of the system 2. For example, the warning signal can represent the state as such, namely that a collision has occurred, a value of the acceleration at the time of collision and the geographical location of the navigation unit 26 at the time of collision. The location of the navigation unit 26 can form the location of the collision detection unit 6, the buoyant apparatus 4 and/or the system 2.

A further example of an advantageous embodiment of the system 2 can also be seen in FIG. 3. Thus, for the system 2 it is preferably provided that the system 2 can have a communication unit 22. The communication unit 22 is coupled to each signal interface 12 of the respective collision detection unit 6 via an associated signal connection 24, so that the warning signal of each collision detection unit 6 can be transmitted to the communication unit 22 via the respective signal connection 24. Further data, represented in particular by a data signal of each communication unit 22, can be transmitted to the communication unit 22 via the respective signal connection 24. The communication unit 22 may be formed separately from the buoyant apparatuses 4. This is shown schematically in FIG. 3 by way of example. However, it is also possible for the communication unit 22 to be formed integrally with one of the collision detection units 6 and/or to form part of one of the buoyant apparatuses 4, in particular part of the buoy 14 or the hose segment 8. In this context, it should be noted that the signal connection 24 between the communication unit 22 and each of the signal interfaces 12 can be wireless or wired. It may also be provided that the signal connection 24 to one of the collision detection units 6 is wired, while the signal connection 24 to another collision detection unit 6 is made by radio connections. The communication unit 22 is configured for generating a transmission signal based on the at least one warning signal or on the previously explained data signal, so that the transmission signal represents the at least one received signal, in particular the at least one received warning signal, and optionally also the data signal. In addition, the communication unit 22 can be designed for transmitting, in particular sending, the transmission signal. Thus, the communication unit 22 can merge or compress the information of the at least one warning signal and optionally also of the data signal, so that a common transmission signal represents the corresponding information. This enables particularly simple, data-lean and fast communication to take place. For example, the transmission signal can be sent to a stationary base station and/or to a receiver on a ship. This information can be evaluated there and appropriate follow-up measures can be initiated.

For completion, it should be mentioned that “having” does not exclude any other elements or steps and “one” or “a” does not exclude a plurality. In addition, it should be mentioned that features which have been described with reference to one of the above exemplary embodiments can also be used in combination with other features of other exemplary embodiments described above. Reference symbols in the claims should not be considered to be limiting.

### LIST OF REFERENCE SYMBOLS

2 System
4 buoyant apparatus
6 Collision detection unit
8 Hose segment
10 Processor unit
12 Signal interface
14 Buoy
16 Floating hose
18 Acceleration sensor
20 first end (of floating hose)
22 Communication unit
24 Signal connection
26 Navigation unit
30 Underwater hose
32 outer layer
34 second end (of floating hose)
35 Flange element
36 Hose wall
38 strengthening support

1.-17. (canceled)

18. A system for generating a warning signal, the system comprising:
a buoyant apparatus that comprises a collision detection unit, which comprises at least one acceleration sensor;
each acceleration sensor is designed for detecting an acceleration acting on the apparatus;
the collision detection unit comprises a processor unit configured to identify a collision of the buoyant apparatus with an unknown object on the basis of the detected acceleration,
the processor unit is designed, upon identification of a collision, to generate a warning signal which represents the identified collision, and
the collision detection unit has a signal interface for transmitting the warning signal.

19. The system of claim 18, the warning signal also represents characteristic data identifying the apparatus (4).

20. The system of claim 18, the warning signal represents the acceleration detected during the collision.

21. The system of claim 18, the warning signal also represents a frequency and/or a number of further collisions, which are identified during a predetermined period after the detection of the initially detected collision.

22. The system of claim 18, the acceleration sensors is arranged and designed for detecting an acceleration in a horizontal plane of the apparatus.

23. The system of claim 18, an acceleration limit value is stored by the collision detection unit (6), wherein the processor unit (10) is configured to positively identify the collision of the apparatus (4) with the unknown object when the at least one detected acceleration is greater than the acceleration limit value.

24. The system of claim 18, the system (2) comprises an interface (12) for receiving weather data and/or marine data, and wherein the system (2) is designed to adapt the acceleration limit value based on the weather data and/or the marine data.

25. The system of claim 18, the signal interface (12) is designed for the wireless transmission of the warning signal.

26. The system of claim 18, the collision detection unit (6) is designed for recording the acceleration detected by the acceleration sensor (18) for a predetermined period of time following an identified collision, and wherein the processor unit (10) is designed for generating a data signal that represents the recorded acceleration, and wherein the signal interface (12) is designed for transmitting the data signal.

27. The system of claim 18, the system (2) comprises a plurality of the buoyant apparatuses (4), each having an associated collision detection unit (6).

28. The system of claim 18, the system (2) comprises a coupling unit (14) and a floating hose (16), which comprises a plurality of floating hose segments (8) that are connected in series, wherein a first end (20) of the floating hose (16) is coupled to the coupling unit, and wherein at least one of the hose segments (8) is designed as a buoyant apparatus (4) with a collision detection unit (6).

29. The system of claim 18, the system (2) comprises a floating buoy (14) and a floating hose (16), which comprises a plurality of floating hose segments (8) that are connected in series, wherein a first end (20) of the floating hose (16) is coupled to the buoy (14), and wherein at least one of the buoy (14) and the hose segments (8) is designed as a buoyant apparatus (4) with a collision detection unit (6).

30. The system of claim 18, the buoy (14) is designed as a buoyant apparatus (4) with a collision detection unit (6) and at least one of the hose segments (8) are each designed as a buoyant apparatus (4) with a collision detection unit (6).

31. The system of claim 30, the acceleration sensors (18) is designed and/or arranged for detecting a lateral acceleration acting on the buoy (14) or the floating hose (16).

32. The system of claim 18, wherein the system (2) comprises a communication unit (22) which is coupled to each signal interface (12) via an associated signal connection (24), so that the warning signal of each collision detection unit (6) and the data signal of each collision detection unit (6) can be transmitted via the respective signal connection (24) to the communication unit (22), wherein the communication unit (22) is configured for generating a transmission signal based on the at least one warning signal and/or data signal, so that the transmission signal represents the at least one receiving signal, and wherein the communication unit (22) is designed for transmitting the transmission signal.

33. The system of claim 18, the communication unit (22) is designed for wirelessly transmitting the transmission signal.

34. The system of claim 29, the system comprises a navigation unit (26) designed to receive a satellite-assisted, wireless navigation signal, wherein the navigation unit (26) is configured to determine a geographical location of the system (2) on the basis of the navigation signal, and wherein the communication unit (22) is configured to adapt the transmission signal in such a way that the transmission signal also represents the geographical location.
